(19) United States
(12) Patent Application Publication
(10) Pub. No.: US 2026/0220756 A1
(43) Pub. Date: Jul. 30, 2026

(54) VISUAL IMAGE STITCHING FOR NON-DESTRUCTIVE INSPECTION

(71) Applicant: EVIDENT CANADA, INC., QUÉBEC (CA)

(72) Inventors: Gabriel Marceau, Levis (CA); Nicolas Badeau, Quebec (CA)

(73) Assignee: EVIDENT CANADA, INC., QUÉBEC (CA)

(21) Appl. No.: 19/457,640

(22) Filed: Jan. 23, 2026

Related U.S. Application Data
(60) Provisional application No. 63/750,003, filed on Jan. 27, 2025.

(51) Int. Cl. G06T 7/00; G06T 7/50; G06T 7/73; G06T 7/80

(52) U.S. Cl. CPC G06T 7/0002; G06T 7/50; G06T 7/74; G06T 7/80; G06T 2207/20221; G06T 2207/30244

(57) ABSTRACT

An acoustic inspection probe assembly can include or use a digital imaging camera to acquire images of a region under inspection. Respective acquired images can be stitched together to form a composite, such as to provide a composite that encompasses an area larger than an individual image amongst the respective acquired images. The composite can be aligned spatially or temporally (or both) with data or imaging corresponding to another non-destructive testing (NDT) modality, such as acoustic inspection or eddy current inspection.

### CROSS REFERENCE TO RELATED APPLICATION

This application claims the benefit of priority under 35 U.S.C. § 119(e) to U.S. Provisional Patent Application No. 63/750,003, filed on Jan. 27, 2025, the entire disclosure of which is hereby incorporated by reference in its entirety.

### BACKGROUND

### Technical Field

This document pertains generally, but not by way of limitation, to non-destructive evaluation, and more particularly, to apparatus and techniques for forming visual imaging corresponding to a region being inspected by another non-destructive inspection modality such as acoustic inspection or eddy current inspection.

### Discussion of Art

Non-destructive testing (NDT) (also referred to as non-destructive inspection) can refer to use of one or more different techniques to inspect regions on or within an object, such as to ascertain whether flaws or defects exist, or to otherwise characterize the object being inspected. Examples of non-destructive test approaches can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include values from, for example, a few hundred kilohertz, to tens of megahertz, as an illustrative example. Various ultrasonic testing (UT) approaches are capable of detecting different feature or defect orientations. For example, zero-degree phased-array (PA) and Total Focusing Method (TFM) are sensitive to planar reflectors parallel to the surface (backwall, laminations). Angle-beam PA and TFM can detect planar flaws at a specified angle or angular range. Other methods can be used for defects that scatter the incident wave in all directions. Time-of-flight diffraction (TOFD) and phase coherence imaging (PCI) can be used for detection of small, point-like flaws and crack tips.

### SUMMARY

In one aspect, the present disclosure provides a method for non-destructive testing. The method may include receiving a position of a probe assembly relative to an object. The probe assembly may include a non-destructive testing sensor and a camera. The method may further include capturing an image of the object at the received position. The method may further include associating the captured image with the received position by mapping the image to a coordinate system. The method may further include updating a composite image of the object by incorporating at least a portion of the captured image into the composite image based on the mapping. The method may further include repeating the receiving, capturing, associating, and updating for multiple positions of the probe assembly to generate a completed composite image representing a region of the object.

In one aspect, the present disclosure provides a system for non-destructive testing. The system includes a processor circuit and a probe assembly comprising a non-destructive testing sensor and a camera. The processor may receive a position of the probe assembly relative to an object, capture an image at the received position, map the captured image to a coordinate system, and update a composite image by incorporating at least a portion of the captured image based on the mapping.

In one aspect, the present disclosure provides a non-transitory computer-readable medium storing instructions. The instructions, when executed, may cause a processor to receive a position and orientation of a probe assembly relative to an object, capture an image at the received position, align the image to a coordinate system based on the received position and orientation, and update a composite image by incorporating at least a portion of the aligned image. The instructions, when executed, may cause the processor to repeat the receiving, capturing, aligning, and updating for multiple probe positions to generate a completed composite image of the object.

In one aspect, the present disclosure provides a method for non-destructive testing with visual image stitching. The method may include obtaining a current position of a probe assembly during non-destructive testing of an object. The current position may be defined based on a coordinate system. The probe assembly may include a non-destructive testing sensor for obtaining non-destructive test data and a camera for capturing images. The method may include capturing a current image of the object via the camera at the current position, mapping pixel positions of the current image to the coordinate system using the obtained current position, stitching a portion of the current image to a composite image based on the mapped pixel positions. The composite image may include portions of previously captured images. The method may include iteratively repositioning the probe assembly to a new current position relative to the object during the non-destructive testing and repeating the obtaining of a current position, the capturing of a current image, the mapping of the pixel positions, and the stitching of a portion of the current image to the composite image to generate a completed composite image of the object.

In one aspect, the present disclosure provides a method for non-destructive testing. The method may include receiving, for each of a plurality of positions of a probe assembly relative to an object under inspection, position data defining a position of the probe assembly in a coordinate system. The probe assembly may include a non-destructive testing sensor and a camera. The method may include acquiring non-destructive test data for the object at the plurality of positions. The method may further include capturing, via the camera, a plurality of images of the object respectively at the plurality of positions and for each captured image, associating the captured image with the coordinate system based on the received position data. The method may further include mapping the captured images to a coordinate system to associate the captured with the plurality of positions and orientations and updating a composite image by incorporating, for each captured image, at least a portion of the captured image into the composite image according to the association with the coordinate system. The method may further include detecting, based on the non-destructive test data, a defect in the object, determining a defect location of the defect within the coordinate system, and displaying at least a portion of the composite image with a visual overlay indicating the defect location within the composite image.

In one aspect, the present disclosure provides a system for non-destructive testing with visual image stitching. The system may include a processor circuit and a probe assembly comprising a non-destructive testing sensor configured to obtain non-destructive test data and a camera configured to capture images. The processor circuit may capture non-destructive test data for an object under inspection via the non-destructive testing sensor while the probe assembly is moved continuously relative to the object. During the movement of the probe assembly, the processor circuit may obtain a current position of the probe assembly. The current position may be defined based on a coordinate system. The processor circuit may capture a current image of the object via the camera at the current position, map pixel positions of the current image to the coordinate system using the obtained current position, and stitch a portion of the current image to a composite image comprising portions of previously captured images based on the mapped pixel positions.

### BRIEF DESCRIPTION OF THE DRAWINGS

FIG. 1 is a block diagram of a system for non-destructive testing with visual image stitching, according to at least one embodiment of the present disclosure.

FIG. 2 is a flowchart of an example of a technique for image localization, alignment, and stitching as part of an inspection operation, according to at least one embodiment of the present disclosure.

FIG. 3 illustrates an example of a composite image created using an image stitching technique, according to at least one embodiment of the present disclosure.

FIG. 4A and FIG. 4B show respective individual images used to construct the composite image of FIG. 3, according to at least one embodiment of the present disclosure.

FIG. 5 shows an illustrative example of a system for non-destructive testing with visual image stitching, according to at least one embodiment of the present disclosure.

FIG. 6 is a flowchart of an example of a method for non-destructive testing with visual image stitching, according to at least one embodiment of the present disclosure.

FIG. 7 is a flowchart of an example of a method for non-destructive testing with visual image stitching, according to at least one embodiment of the present disclosure.

FIG. 8 is a flowchart of an example of a method for non-destructive testing with visual image stitching, according to at least one embodiment of the present disclosure.

FIG. 9 is a block diagram of an example comprising a machine upon which any one or more of the techniques (e.g., methodologies) discussed herein may be performed, according to at least one embodiment of the present disclosure.

### DESCRIPTION

The present subject matter can include acquiring imaging data such as to provide a visual representation, or “twin,” of a region corresponding to acquired Non-Destructive Testing (NDT) data, such as C-Scan acoustic imaging data. Such a visual representation (e.g., corresponding to digital images of a surface of an object under test, in the visible spectrum) can help facilitate semi-automated or fully-automated inspection of structures that are large or otherwise difficult to physically access for in-person visual inspection.

As an example illustration, a two-dimensional digital imaging camera located on or within an NDT inspection probe assembly can be used in conjunction with acquired data indicative of three-dimensional (e.g., (x, y, z) position and orientation (e.g. yaw, pitch and roll)) of the probe assembly relative to the object under inspection. The present subject matter can include an image stitching technique where image segments are aggregated to form a composite, such as to create a comprehensive visual overview of an inspected region, regardless of its length or how challenging it is for an operator to access. A stitching process can be applied in a single direction, such as for circumferential or longitudinal weld inspections, or in two directions, such as supporting inspection of composite parts (e.g., airfoils such as wind turbine blades, airplane wings, or aircraft control surface structures) and/or surfaces.

The present teachings can be used to address various challenges. For example, embodiments of the techniques and apparatuses disclosed herein can allow an operator to remotely visually assess a defect inspection area, helping to determine whether a physical inspection (e.g., in person) is necessary. This remote visual access can enhance operator safety by reducing or eliminating a need for physical access to hard-to-reach or dangerous locations (e.g., at heights or in remote locales). Embodiments of the techniques and apparatuses disclosed herein can allow a visual reference of a defect location, facilitating easier localization for manual or visual inspections afterwards. Surface defects may be visible in a resulting 2D image, enhancing inspection accuracy, because such visible defects may correlate with indications shown in other NDT modalities, such as indicated by acoustic or eddy current inspection.

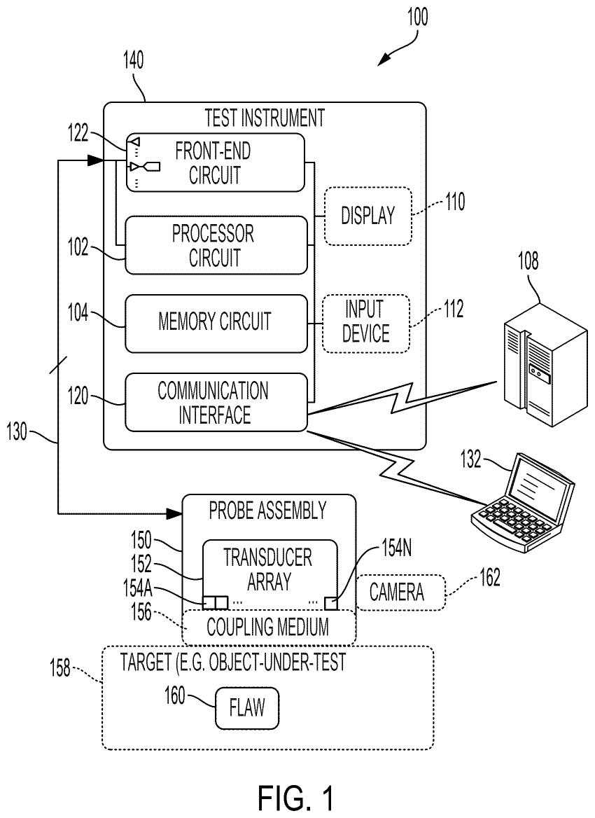

FIG. 1 illustrates generally an example comprising an inspection system 100, such as can be used to perform at least a portion of one or more techniques as shown and described herein. The inspection system 100 can include a test instrument 140, such as a hand-held or portable assembly. The test instrument can be electrically coupled to a probe assembly 150, such as using a multi-conductor interconnect 130. The probe assembly can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly configuration can be used, such as to allow a test instrument to be used with various different probe assemblies. In some examples, the transducer array includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium during testing, or testing can be conducted with an interface between the probe assembly and the target otherwise immersed in a coupling medium. Optionally, according to the present subject matter, a camera 162 (e.g., a digital imaging camera) can be included on or within the probe assembly, such as to obtain a visual image of a surface of the target. Acquired images can be stitched together, such as logged or displayed in alignment with acquisition of non-destructive inspection data acquired using the transducer array. For automated applications, visual imaging may provide verification that the intended structures were adequately inspected, or may reveal visual cues of underlying flaws or defects, or measurement errors, that correspond to indications present in the acquired non-destructive inspection data.

The test instrument can include digital and analog circuitry, such as a front-end circuit 122 including one or more transmitter signal chains, receiver signal chains, or switching circuitry (e.g., transmit/receive switching circuitry). The transmitter signal chain can include amplifier and filter circuitry, such as to provide transmit pulses for delivery through the interconnect to the probe assembly for insonifying the target, such as to image or otherwise detect a flaw 160 on or within the target structure by receiving scattered or reflected acoustic energy elicited in response to the insonification.

While FIG. 1 shows a single probe assembly and a single transducer array, other configurations can be used, such as multiple probe assemblies connected to a single test instrument, or multiple transducer arrays used with a single probe assembly or multiple probe assemblies for pitch/catch inspection modes. Similarly, a test protocol can be performed using coordination between multiple test instruments, such as in response to an overall test scheme established from a master test instrument or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receiver signal chain of the front-end circuit can include one or more filters or amplifier circuits, along with an analog-to-digital conversion facility, such as to digitize echo signals received using the probe assembly. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument. The processor circuit can be coupled to a memory circuit 104, such as to execute instructions that cause the test instrument to perform one or more of acoustic transmission, acoustic acquisition, processing, or storage of data relating to an acoustic inspection, or to otherwise perform techniques as shown and described herein. The test instrument can be communicatively coupled to other portions of the system, such as using a wired or wireless communication interface 120.

For example, performance of one or more techniques as shown and described herein can be accomplished on-board the test instrument or using other processing or storage facilities such as using a compute facility or a general-purpose computing device such as a laptop, tablet, smart-phone, desktop computer, or the like. For example, processing tasks that would be undesirably slow if performed on-board the test instrument or beyond the capabilities of the test instrument can be performed remotely (e.g., on a separate system), such as in response to a request from the test instrument. Similarly, storage of imaging data or intermediate data such as A-scan matrices of time-series data or other representations of such data, for example, can be accomplished using remote facilities communicatively coupled to the test instrument. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

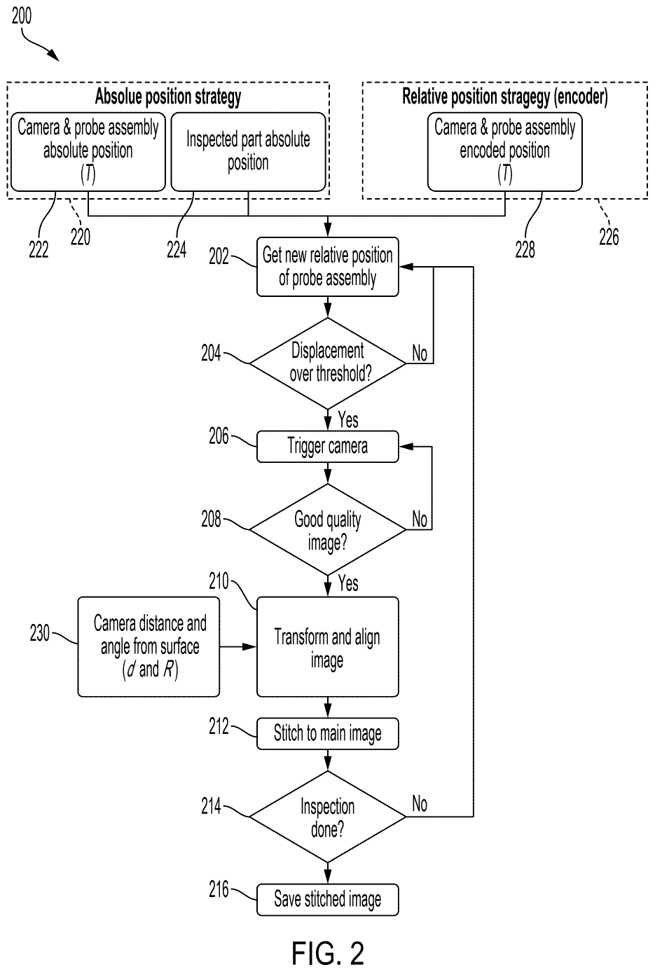

Referring to image acquisition and stitching techniques, the following examples are provided. FIG. 2 shows an illustrative example of a technique 200, such as a machine-implemented method for image localization, alignment, and stitching, associated with an inspection operation. The technique may be implemented using any of the apparatuses disclosed herein, such as, for example using the system disclosed with respect to FIG. 1.

The technique may include getting 202 a new relative position of the probe assembly. For example, a position of the probe assembly may be received or otherwise obtained. The position of the probe assembly may be a position relative to the object under inspection.

As shown in FIG. 2, there are at least a couple of different strategies that can be used to acquire position data, such as to localize a digital imaging camera relative to an object under inspection. A representation of such a relative position can be represented as “T” (explained further herein).

A first approach can include determining the absolute position of both the probe assembly and the test piece, then computing a difference between them. Each image can then be associated with a new relative position.

For example, according to at least one embodiment of the technique, the first approach for obtaining the position (T) of the probe assembly (e.g., the camera) is based on an absolute position strategy 220. Employing the absolute position strategy can include determining an absolute position of the probe assembly 222 and an absolute position of the object (e.g., the test piece) 224, then computing a difference between the absolute probe assembly position and the absolute object position to determine the relative position of the probe assembly. As discussed further herein, the probe assembly may be iteratively repositioned as the object is inspected, and an image may be captured at each position. A new relative position of the probe assembly may be determined each time the probe assembly is repositioned. Each image can then be associated with a new relative position.

A second approach is to use a current encoded position of the inspection head.

For example, according to at least one embodiment of the technique, the second approach for obtaining the position (T) of the probe assembly is based on a relative position strategy 226. Employing the relative position strategy can include determining an encoded position of the probe assembly. For example, the probe assembly may be repositioned using a robotic device, such as a robotic arm. The robotic device may include one or more motors for adjusting the position of the probe assembly. The robotic device may include one or more encoders that can be employed to determine the relative position of the probe assembly based on translating rotational movement of the one or more motors into positional data.

According to the technique, the new relative position of the probe assembly may be compared to a previous relative position of the probe assembly to determine a displacement of the probe assembly. The displacement of the probe assembly may be compared 204 to a displacement threshold. If the displacement threshold does not satisfy a displacement threshold (e.g., not over a displacement threshold), then the technique may proceed by passively waiting until the probe assembly moves to a new position that satisfies the displacement threshold or by actively moving the probe assembly to a new position that satisfies the displacement threshold.

If the displacement threshold is satisfied, then the technique may proceed by triggering capture 206 of an image via the camera. Comparing the displacement of the probe assembly from its previous position and capturing the image when the displacement satisfies the displacement threshold can ensure that images are not captured too frequently and/or are not captured at positions that would result images that significantly overlap.

According to the technique, an image quality of the captured image may be assessed 208. For example, the system may analyze the image to determine various image quality metrics such as a sharpness metric, an exposure metric, and/or a noise metric. If the determined metric does not satisfy a corresponding image quality threshold (e.g., a sharpness threshold, an exposure threshold, and/or a noise threshold), the image may be recaptured.

In some implementations, the system may determine a sharpness metric for comparison to a sharpness threshold. The sharpness metric may be calculated using a Laplacian variance method, which measures the variance of the Laplacian of the image to quantify edge detail. A higher variance generally indicates better focus. If the computed Laplacian variance falls below a predefined sharpness threshold (e.g., 100.0 for an 8-bit grayscale image), the image may be considered out of focus and recaptured.

In some implementations, the system may determine an exposure metric for comparison to an exposure threshold. For example, the exposure metric may be calculated as the mean pixel intensity of the image. A properly exposed image may have a mean intensity within a target range (e.g., 100-150 on an 8-bit scale). If the mean intensity falls outside this range, indicating underexposure or overexposure, the exposure metric may fail the exposure threshold and the image may be recaptured.

In some implementations, the system may determine a noise metric for comparison to a noise threshold. For example, the noise metric may be calculated using a signal-to-noise ratio (SNR), defined as the ratio of the mean pixel intensity to the standard deviation of pixel intensity in a uniform region of the image. A higher SNR generally indicates less noise. If the SNR falls below a predefined noise threshold (e.g., 20 dB), the image may be considered excessively noisy and recaptured.

According to the technique, the image may be transformed and aligned 210. For example, if the captured image satisfies the image quality threshold, then the technique may proceed by transforming and aligning the image, as discussed further herein.

To transform and align the image, the camera's distance (d) from a surface of the object being imaged and orientation (R) may be obtained 230.

A camera's distance from the surface being photographed (d) and the rotation between the camera and the surface (R) can be measured using external sensors (such as laser profilers, 3D cameras, or multiple distance sensors) or inferred if the geometry of the object (e.g., the test piece) is known or easily ascertainable. An example technique for transforming and aligning the image is discussed further herein.

According to some embodiments of the technique, the transformed and aligned image may be stitched to a main image each time a new image is captured. For example, each time an image is acquired at a new position of the probe assembly, the transformed and aligned image may be stitched to a composite image generated based on iteratively stitching together images captured at the previous positions of the probe assembly. Thus, in some embodiments, a main image (e.g., the composite image) may be incrementally generated as the probe assembly is repositioned and new images are captured.

If the inspection is done 214 (e.g., determined to be complete), the stitched image is saved 216. If the inspection is not complete, then the probe assembly may be repositioned, the new relative position may be determined, and a new image may be captured, as discussed above. This process may iterative repeat until the inspection is complete.

According to some embodiments of the technique, the transformation, alignment, and/or image stitching process can be performed separately, such as after inspection acquisition, where multiple captured images are saved along with their associated relative positions. A machine-implemented technique can compile these images and establish the stitching. Alternatively, or in addition, the stitching process can be done in real-time as the inspection takes place, as discussed above.

The following section details a mathematical model (e.g., an example technique) for scaling and aligning an image onto a stitched composite using the camera's (e.g., the probe assembly's) current relative position and orientation: x, y, z, w, p, and r (e.g., where x, y, z, define three-dimensional positional coordinates of the camera and where w, p, and r respectively correspond to the yaw, pitch, and roll of the camera). 2D image data from a particular picture (e.g., image), represented in the camera's coordinate system {C}, can be transformed into another coordinate system, such as into the world coordinate system {W}. For simplicity, the origin of the world coordinate system can be defined as the origin of the object (e.g., the test piece).

The x, y, z coordinates defining the relative position of the camera can be used to create the following translation vector T, defined as the camera origin expressed in the world reference frame:

$$T = [ \begin{matrix}{T}_{x} \\ {T}_{y} \\ {T}_{z}\end{matrix} ]$$

The orientation of the camera relative to the world coordinate system may be represented by a rotation matrix R. In one example implementation, the rotation matrix R is computed using a yaw-pitch-roll convention, wherein the yaw angle w represents a rotation about a world Z-axis, the pitch angle p represents a rotation about a world Y-axis, and the roll angle r represents a rotation about a world X-axis. The rotation matrix R may be expressed as:

$$R = {R}_{z} ( w ) {R}_{y} ( p ) {R}_{x} ( r ) ,$$

using extrinsic rotations about fixed world axes, applied in the listed order, where

$${R}_{x} ( r ) = [ \begin{matrix}1 & 0 & 0 \\ 0 & cos r & - s in r \\ 0 & sin r & cos r\end{matrix} ] ,$$

$${R}_{y} ( p ) = [ \begin{matrix}cos p & 0 & sin p \\ 0 & 1 & 0 \\ - sin p & 0 & cos p\end{matrix} ] ,$$

$${R}_{z} ( w ) = [ \begin{matrix}cos w & - sin w & 0 \\ sin w & cos w & 0 \\ 0 & 0 & 1\end{matrix} ] .$$

In this example, R is defined as the rotation that maps vectors expressed in the camera reference frame {C} into the world reference frame {W} (i.e., camera-to-world). Accordingly, the inverse mapping (world-to-camera) can be represented by R^{T} (for a pure rotation).

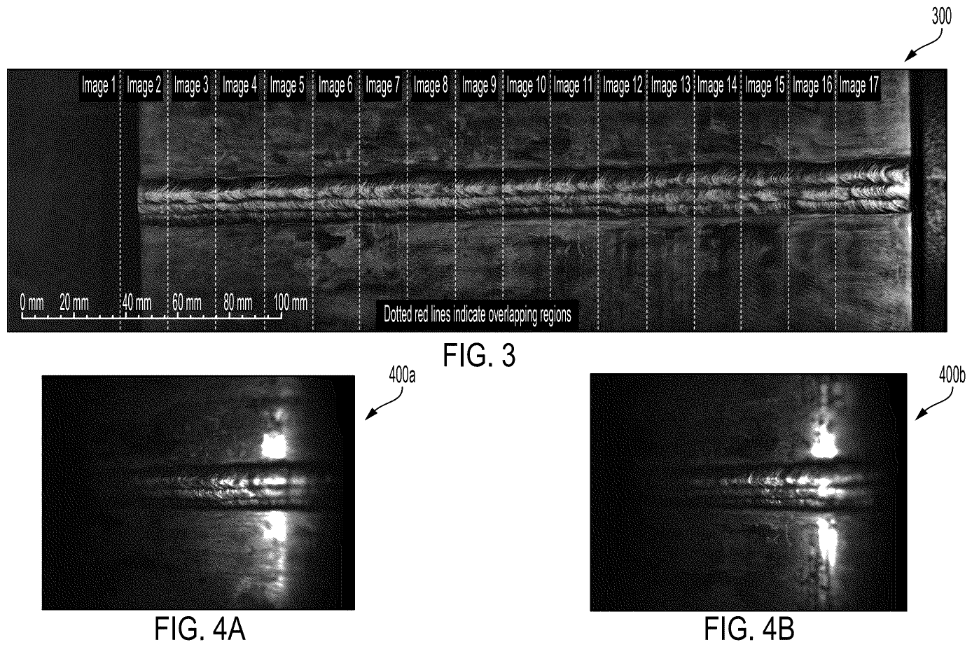

The position and orientation of the camera (x, y, z, w, p, and r) can be obtained using multiple methods. For example, in the case of a static, flat, and/or non-angled piece under inspection, such as the one shown in FIG. 3, these values could correspond directly to the position of a locomotion mechanism (e.g., used for moving the probe assembly). FIG. 3 shows an image 300 of a ~300 mm length weld under inspection reconstructed using image localization as described herein. In more dynamic inspections where the test pieces are not flat, such as wagon tanks or pressurized full tanks, these values can be obtained directly or derived from measurement devices such as distance sensors, laser profilers, 3D cameras, or the like.

Generally, a digital imaging camera in a particular image acquisition mode has intrinsic properties that define its optical characteristics, such as the focal length f expressed in pixels units. If a pinhole camera model is employed, an intrinsic camera matrix (e.g., defining optic characteristic of a camera) can be represented as:

$$K = [ \begin{matrix}{f}_{x} & 0 & {c}_{x} \\ 0 & {f}_{y} & {c}_{y} \\ 0 & 0 & 1\end{matrix} ] {K}^{- 1} = [ \begin{matrix}\frac{1}{{f}_{x}} & 0 & - \frac{{c}_{x}}{{f}_{x}} \\ 0 & \frac{1}{{f}_{y}} & - \frac{{c}_{y}}{{f}_{y}} \\ 0 & 0 & 1\end{matrix} ]$$

where cₓ and c_{y} are the coordinates of the image principal point, which may be obtained via calibration and is often near the image center in u, v coordinates. For each pixel in the image, with integer coordinates u and v, a corresponding ray direction in the camera frame can be expressed as

$${ℓ}_{c} = {K}^{- 1} [ \begin{matrix}u \\ v \\ 1\end{matrix} ] .$$

In the examples described herein, a known average depth along the camera optical axis between the camera and the inspected surface of the object may be used to scale the ray direction to a 3D point in the camera frame:

$$[ \begin{matrix}{X}_{c} \\ {Y}_{c} \\ {Z}_{c}\end{matrix} ] = d {ℓ}_{c} = {dK}^{- 1} [ \begin{matrix}u \\ v \\ 1\end{matrix} ]$$

In the equation above, d represents an approximate stand-off distance along the camera Z-axis (optical axis) to the inspected surface. This value can be calculated using the known positions of the camera and the object or measured using other techniques. This constant-d approximation can be used, for example, when the inspected surface is approximately planar and approximately fronto-parallel to the camera (e.g., small pitch/roll and small field-of-view), such that a single representative d provides acceptable geometric accuracy. Otherwise, d can be treated as a per-pixel depth d(u, v), or a ray-surface intersection can be performed using a known surface model (e.g., a plane in {W} or a mesh), to determine the corresponding 3D world point for each pixel.

Each pixel, now in the camera's reference frame, can be assigned coordinates in the world reference frame using the following transformation:

$$[ \begin{matrix}{X}_{w} \\ {Y}_{w} \\ {Z}_{w}\end{matrix} ] = R ( [ \begin{matrix}{X}_{c} \\ {Y}_{c} \\ {Z}_{c}\end{matrix} ] ) + T$$

Accordingly, to transform image pixel coordinates (u and v) into world coordinates (X_{w}, Y_{w}, Z_{w}), the following computation may be performed:

$$[ \begin{matrix}{X}_{w} \\ {Y}_{w} \\ {Z}_{w}\end{matrix} ] = R ( {dK}^{- 1} [ \begin{matrix}u \\ v \\ 1\end{matrix} ] ) + T$$

The following section details example techniques for image stitching. As seen in FIG. 3, an example case is shown where movement occurs in only one direction (e.g., along the x axis), and the camera is perpendicular to the surface (e.g., of the object) without any skew. This corresponds to the following translation and rotation matrices:

$${T}_{i} = [ \begin{matrix}{T}_{{x}_{i}} \\ {T}_{{y}_{0}} \\ {T}_{{z}_{0}}\end{matrix} ] R = [ \begin{matrix}1 & 0 & 0 \\ 0 & 1 & 0 \\ 0 & 0 & 1\end{matrix} ]$$

where T_{y}_{₀} and T_{z}_{₀} are kept constant.

The complete transformation (e.g., of images pixels coordinates (u and v) into world coordinates (X_{w}, Y_{w}, Z_{w})) in this case becomes:

$$[ \begin{matrix}{X}_{w} \\ {Y}_{w} \\ {Z}_{w}\end{matrix} ] = [ \begin{matrix}1 & 0 & 0 \\ 0 & 1 & 0 \\ 0 & 0 & 1\end{matrix} ] ( d [ \begin{matrix}1 / {f}_{x} & 0 & - {c}_{x} / {f}_{x} \\ 0 & 1 / {f}_{y} & - {c}_{y} / {f}_{y} \\ 0 & 0 & 1\end{matrix} ] [ \begin{matrix}u \\ v \\ 1\end{matrix} ] ) + [ \begin{matrix}{T}_{{x}_{i}} \\ {T}_{{y}_{0}} \\ {T}_{{z}_{0}}\end{matrix} ]$$

The value of d, the depth between the camera and the inspected surface (e.g., of the object), is well known (e.g., in this example), as the inspection apparatus and trajectory are controlled to maintain a constant distance (e.g., along the z axis) from the inspected surface.

In this example, multiple images may be stitched together by combining strips (e.g. extending perpendicular to the scan direction) corresponding to portions of each image. According to this example, a determined proportion of pixels may be selected from a middle (e.g., central) portion of each image, using the position (e.g., along the x axis) of the camera where each image was captured, and then adding these strips (e.g., in the scan direction along the x axis) to the stitched image, such that the stitched image is a composite of such strips. For example, FIG. 3 shows 17 such strips numbered Image 1 to Image 17.

The width of each strip may be directly proportional to the distance traveled between two subsequent images, as shown by the following relationship:

$${w}_{s t r i p} \approx {s}_{x} \vert {X}_{{w}_{i}} - {X}_{{w}_{i - 1}} \vert$$

where i represents a particular image index, and where sₓ is the pixel-per-world scaling along the x-axis (e.g., pixels/mm). In this one-direction scan example, X_{w}_{ᵢ} can correspond to the world x-coordinate of the camera origin at capture i (i.e., X_{w}_{ᵢ}=Tₓ_{ᵢ}). In implementations using the pinhole model and constant-d approximation, sₓ may be derived from camera parameters (e.g., sₓ≈fₓ/d under a fronto-parallel planar assumption).

In other example cases wherein translation and rotation components are present, scaling and transformation of the individual images using T and R may generally be performed before strips or sections are selected and added to the stitched images.

While FIG. 3 illustrates an example of a stitched image created using the process explained earlier, FIG. 4A and FIG. 4B show respective individual images 400a and 400b used to construct the stitched image, where FIG. 4A shows image “#7” in the acquisition sequence and FIG. 4B shows image “#9” in the acquisition sequence used to form the composite image of FIG. 3.

In some examples, the stitching process may occur in two directions, meaning that pixels are added along both the u and v axes of the image (e.g., instead of adding vertical strips, rectangular blocks can be added to the composite). The dimensions of these blocks (e.g., portions of images added to the composite) can adhere to the following proportionality:

$${w}_{b l o c k} \approx {s}_{x} \vert {X}_{{w}_{i}} - {X}_{{w}_{i - 1}} \vert$$

$${h}_{b l o c k} \approx {s}_{y} \vert {Y}_{{w}_{i}} - {Y}_{{w}_{i - 1}} \vert$$

In this two-direction case, X_{w}_{ᵢ} and Y_{w}_{ᵢ} can correspond to the world coordinates of the camera origin at capture i (e.g., X_{w}_{ᵢ}=Tₓ_{ᵢ}, Y_{w}_{ᵢ}=T_{y}_{ᵢ}), and sₓ, s_{y} represent pixel-per-world scaling factors (e.g., pixels/mm) along the corresponding axes.

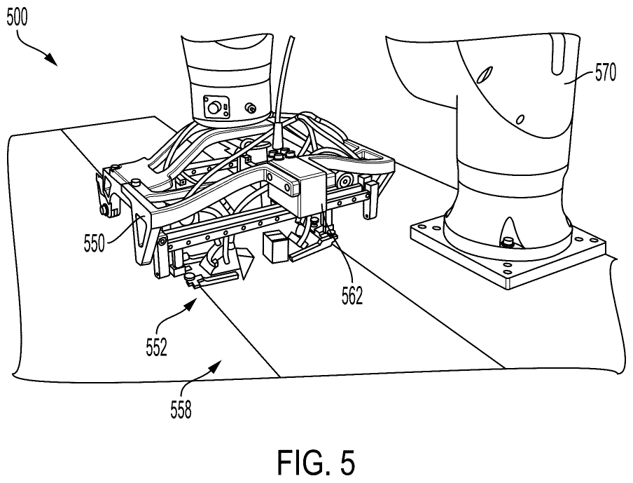

FIG. 5 shows an illustrative example of a system 500 for visual image stitching in non-destructive testing. The system is shown inspecting a target of an object 558 that, in this example, is a weld line connecting metal sheets. The system comprises a probe assembly 550 that includes transducer elements 552 and an attached digital imaging camera 562, such as can be used to acquire the images shown in FIG. 4A and FIG. 4B, corresponding to a weld inspection application. In some implementations, the probe assembly is movable relative to the object by a robotic arm 570. Any aspect discussed with respect to the system of FIG. 1 may be implemented in the system of FIG. 5 and vice versa.

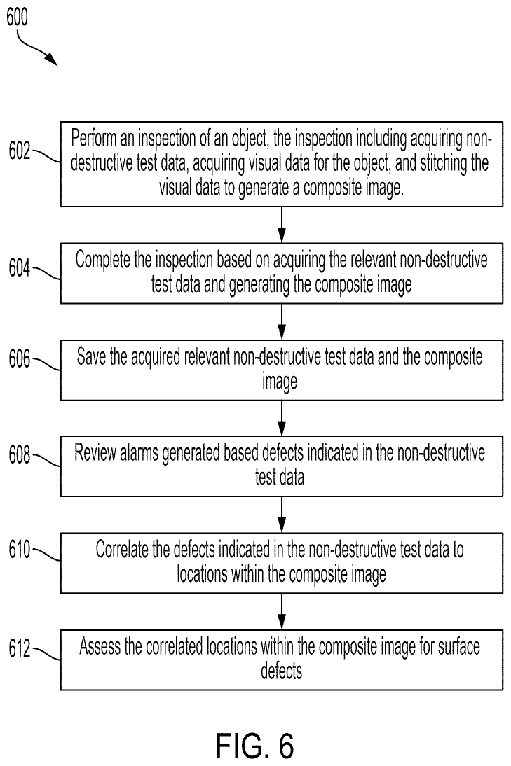

FIG. 6 is a flowchart of an example of a method 600 for non-destructive testing with visual image stitching. Aspects of the method may be performed using any of the apparatuses and/or techniques discussed further herein. For example, aspects of the method may be performed using the system of FIG. 1 and/or according to the techniques discussed with respect to FIG. 2.

According to the method, an inspection is performed 602. Performing the inspection may include gathering non-destructive testing (NDT) data using one or more modalities, such as via ultrasonic testing (UT), phased-array ultrasonic testing (PAUT), and/or eddy current array (ECA) inspection. During this step, a probe assembly may be moved relative to the object under test, and both NDT data (e.g., UT, PAUT, and/or ECA data) and visual images are captured. The data may be acquired according to the technique discussed with respect to FIG. 2. Contemporaneously with the inspection, the system may generate a composite image that maps each pixel of the captured images to its corresponding physical location on the object.

According to the method, the inspection is completed 604. Based on acquiring the relevant data, the inspection process may be concluded. Completing the inspection may include verifying that all regions of interest for the objection have been adequately covered and that the corresponding NDT and visual data for the regions have been collected. For example, an operator or automated system may confirm that the probe assembly has traversed an entire target object (e.g., an entire weld or composite part), and that no gaps remain in the composite image or NDT dataset.

According to the method, the acquired data and the composite image is saved 606. Based on completion of the inspection, the acquired NDT data and the composite stitched image may be saved for traceability and/or further analysis. Saving the data can ensure that all inspection records are securely stored, enabling future review, regulatory compliance, and/or quality assurance. For example, the system may archive ultrasonic C-Scan data, visual composites, and metadata such as probe positions and inspection timestamps in a centralized database.

According to the method, alarms generated based on defects indicated in the NDT data are reviewed 608. For example, the system may present a notification (e.g., via a display screen) indicating location(s) on the object where alarms were triggered based on defects identified during the inspection. Alarms may be generated based on threshold criteria in the NDT data, such as signal amplitude anomalies or defect indications.

According to the method, the defects are correlated 610 to locations within the composite image. For example, defect locations identified in the NDT data are paired with locations in the stitched image for clear visualization. This correlation may include mapping the coordinates of detected flaws, such as cracks or voids, to corresponding coordinates of the composite image of the inspected region. For example, if a flaw is detected in the ultrasonic data at a specific position, its location may be highlighted on the visual composite (via the display screen), allowing an operator to visually correlate subsurface indications with surface features.

According to the method, the correlated locations within the composite images are assessed 612 for surface defects. For the correlated locations, the operator can assess whether a detected subsurface defect corresponding to an observable surface defect in the visual composite that warrants a physical inspection of the identified location. The system may provide tools for zooming in on the stitched image, measuring defect dimensions, or comparing visual indications with NDT results. Based on this assessment, the operator may schedule a manual inspection, perform repairs, and/document the findings for future reference.

According to some aspects of the method, at least a portion of the composite image may be displayed with a visual overlay indicating the defect location within the composite image. In certain implementations, the overlay can include graphical markers such as colored dots, bounding boxes, or heatmap regions that correspond to coordinates of detected flaws derived from NDT data. The overlay may be dynamically generated by mapping defect positions from the inspection coordinate system to pixel positions within the stitched composite image.

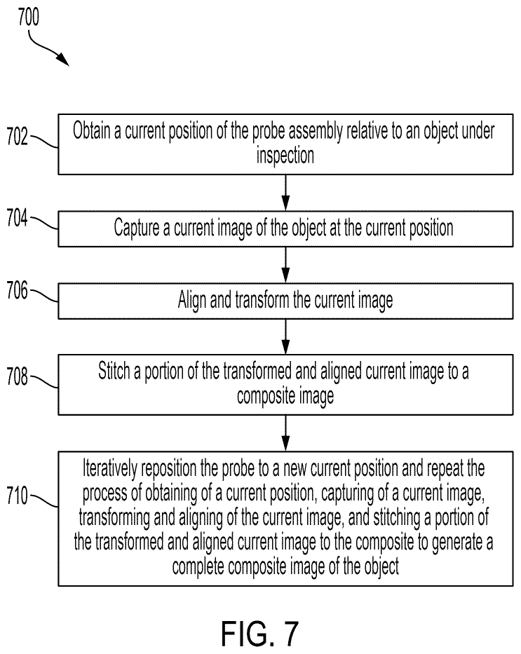

FIG. 7 is a flowchart of an example of a method 700 for non-destructive testing with visual image stitching. Aspects of the method may be performed using any of the apparatuses and/or techniques discussed further herein. For example, aspects of the method may be performed using the system of FIGS. 1 and 5 and/or according to the techniques discussed with respect to FIGS. 2 and 6.

According to the method, a current position of the probe assembly relative to an object under inspection is obtained 702. The current position may be defined based on a coordinate system. For example, the coordinate system may be a three-dimensional system with x, y, and z axes. The object under inspection may have a reference point, such as a physical marker or geometric feature, that defines the origin of the coordinate system. The probe assembly may include a non-destructive testing sensor for obtaining non-destructive test data at the current position and a camera for capturing images.

According to the method, a current image of the object is captured via the camera at the current position 704. The camera may acquire a visual image of the surface or region of the object that is accessible from the probe assembly's current position. This image may be used to document the condition of the object or to facilitate further analysis in combination with non-destructive test data.

According to the method, the current image is transformed and aligned 706. Transforming and aligning the image may include mapping the pixel positions of the captured image to the coordinate system using the obtained current position of the probe assembly. For example, the transformation may use the probe's spatial coordinates and orientation to ensure that the image is accurately placed within the composite image, as discussed further herein, allowing for precise spatial correlation between stitched images portions and/or between visual and test data.

According to the method, a portion of the transformed and aligned current image is stitched to a composite image 708. Stitching may include selecting a relevant portion of the current image and combining it with portions of previously captured images in the composite image based on their mapped pixel positions. The composite image may be incrementally built in real time as the inspection progresses or after the inspection during post processing, resulting in a comprehensive visual representation of the inspected region.

According to the method, the probe assembly is iteratively repositioned to a new current position relative to the object and the process of obtaining of a current position, capturing a current image, transforming and aligning the current image, and stitching a portion of the transformed and aligned current image to the composite image is repeated 710 to generate a complete composite image of the object. For example, after each image capture and stitching operation, the probe assembly may be moved to a new position, either manually or using automated mechanisms such as a robotic arm, and the steps of obtaining a current position, capturing a current image, transforming and aligning the image, and stitching the image to the composite may be repeated at the new position. This iterative process can continue until the entire region of interest has been inspected and a complete composite image of the object is generated.

According to some aspects of the method, obtaining the current position of the probe assembly may include obtaining a position and orientation of the camera. The orientation may be defined by yaw, pitch, and roll angles, which describe the camera's rotation about three perpendicular axes. This information may be used to more accurately determine the spatial attitude of the camera relative to the object under inspection.

According to some aspects of the method, the position of the camera may be defined by a translation vector, and the orientation may be defined by a rotational matrix. The position of each pixel of the current image relative to the frame of the camera may be represented by a camera frame pixel vector. Transforming and aligning the current image may include applying the rotational matrix and the translation vector to the camera frame pixel vector for each pixel, thereby generating a coordinate system pixel vector that maps the pixel's position within the coordinate system.

According to some aspects of the method, defining the position of each pixel of the current image relative to the frame of the camera may include defining an optic characteristic matrix for the camera. The optic characteristic matrix may include a focal length expressed in pixel units and image principal point coordinates. The method may further include determining a depth of the image based on a distance between the camera and the object at the current position, and applying the depth and the optic characteristic matrix to integer coordinates of each pixel to generate the camera frame vector.

According to some aspects of the method, stitching a portion of the transformed and aligned current image to the composite image may include selecting a subset of pixels from the current image based on a distance traveled by the camera between the current position and a previous position. The selected pixels may be added to the composite image according to their mapped positions in the coordinate system, allowing the composite image to accurately reflect the spatial relationship between successive images.

According to some aspects of the method, obtaining the current position of the probe assembly relative to the object under inspection may include obtaining an absolute position of the probe assembly and comparing it to an absolute position of a reference point of the object. The reference point may be a physical marker, geometric feature, or other defined location on the object that serves as the origin for the coordinate system.

According to some aspects of the method, obtaining the current position of the probe assembly relative to the object under inspection may include determining the current position based on a previous position of the probe assembly and encoder data from one or more motors used to reposition the probe assembly. For example, a robotic arm used for repositioning the probe assembly may include multiple motors for articulating corresponding joints, pivot points, etc. of the robotic arm. The encoder data may provide information about the movement of the probe assembly, enabling calculation of its new position relative to the object.

According to some aspects of the method, the method may further include determining a displacement of the probe assembly from a previous position to the current position, comparing the displacement to a displacement threshold, and refraining from capturing the current image until the probe assembly has moved a sufficient distance to satisfy the displacement threshold. This approach may help avoid capturing redundant or significantly overlapping images and improve the efficiency of the inspection process.

According to some aspects of the method, the method may further include comparing an initially captured current image to an image quality threshold and recapturing the current image if the initial image fails to satisfy the threshold. For example, the initially captured current image may be analyzed to determine various image quality metrics such as a sharpness metric, an exposure metric, and/or a noise metric. If the determined metric does not satisfy a corresponding image quality threshold (e.g., a sharpness threshold, an exposure threshold, and/or a noise threshold), the current image may be recaptured.

According to some aspects of the method, the method may further include obtaining non-destructive test data via the non-destructive testing sensor at each current position of the probe assembly. The non-destructive test data may include ultrasonic testing (UT) data, phased-array ultrasonic testing (PAUT) data, and/or eddy current array (ECA) data, allowing for comprehensive assessment of the object's condition (e.g., subsurface condition) using multiple inspection modalities.

According to some aspects of the method, the method may further include detecting a defect of the object based on the non-destructive test data, determining a location within the composite image corresponding to the position of the detected defect, and providing a visual indication of the defect's location via a display screen. This can enable operators to quickly identify and assess areas of concern within the composite image.

According to some aspects of the method, determining a location within the composite image corresponding to a position of the detected defect may include determining the position of the detected defect within the coordinate system and mapping that position to a corresponding location within the composite image. This mapping can allow for precise spatial correlation between detected defects and their visual representation in the composite image.

According to some aspects of the method, at least a portion of the composite image may be displayed with a visual overlay indicating the defect location within the composite image. In certain implementations, the overlay can include graphical markers such as colored dots, bounding boxes, or heatmap regions that correspond to coordinates of detected flaws derived from NDT data. The overlay may be dynamically generated by mapping defect positions from the inspection coordinate system to pixel positions within the stitched composite image.

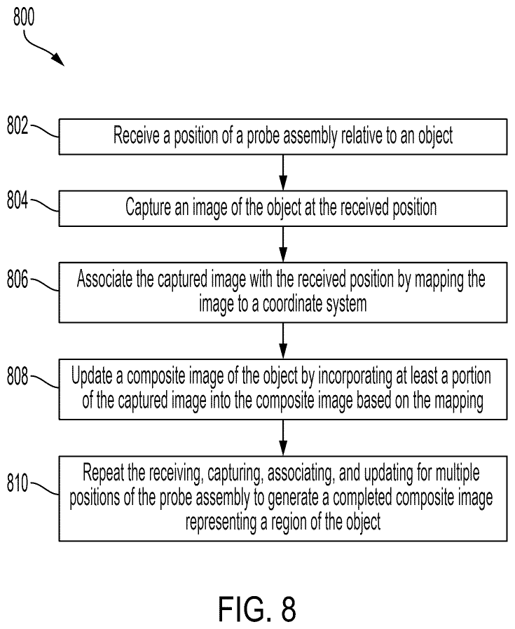

FIG. 8 is a flowchart of an example of a method 800 for non-destructive testing, according to the present disclosure. The method may be implemented using any of the apparatuses and techniques described herein, such as the systems shown in FIGS. 1 and 5 and/or the techniques discussed with respect to FIGS. 2 and 6. Aspects of the method of FIG. 8 may be incorporated into the method of FIG. 7 and vice versa.

According to the method, a position of a probe assembly relative to an object is received 802. The probe assembly includes a non-destructive testing sensor and a camera. The position may be defined based on a coordinate system, such as a three-dimensional system with x, y, and z axes. The position may be obtained as an absolute position compared to a reference point of the object or determined based on a previous position and encoder data from one or more motors that reposition the probe assembly.

At the received position, an image of the object is captured 804 via the camera. The image may represent a surface region of the object accessible from the probe assembly's current position and may be used for visual documentation or correlation with non-destructive test data.

The captured image is associated with the received position by mapping the image to the coordinate system 806. Mapping may include defining the position of the camera as a translation vector, defining its orientation as a rotational matrix, and applying these to pixel coordinates of the image. Each pixel may be represented by a camera-frame pixel vector, which is transformed into a coordinate-system pixel vector using the translation vector and rotational matrix.

A composite image of the object is updated 808 by incorporating at least a portion of the captured image based on the mapping. The portion selected may depend on the displacement of the probe assembly between successive positions, ensuring efficient stitching without excessive overlap. The composite image may be built incrementally in real time or during post-processing to provide a comprehensive visual representation of the inspected region.

The steps of receiving a position, capturing an image, associating the image with the position, and updating the composite image are repeated 810 for multiple positions of the probe assembly to generate a completed composite image representing a region of the object. Repositioning may be performed manually or using automated mechanisms such as a robotic arm.

In some aspects, the method further includes receiving an orientation of the camera at each position, where the orientation comprises one or more rotational components such as yaw, pitch, and roll.

Associating the captured image with the received position may include defining the camera-frame pixel vector using an intrinsic characteristic matrix for the camera, which includes focal length and principal point coordinates, and determining a depth of the image based on the distance between the camera and the object. The depth and intrinsic characteristic matrix may be applied to integer pixel coordinates to generate the camera-frame pixel vector.

Updating the composite image may include selecting a region of the captured image based on the displacement of the probe assembly between successive positions and incorporating the selected region into the composite image according to its mapped position.

The method may further include determining a displacement between the received position and a previous position, comparing the displacement to a displacement threshold, and capturing the image in response to the displacement satisfying the threshold.

The method may also include evaluating an image quality metric against a quality threshold and repeating capture if the image quality metric fails to satisfy the threshold, ensuring that only images of sufficient quality are used in the composite image. For example, the image may be analyzed to determine various image quality metrics such as a sharpness metric, an exposure metric, and/or a noise metric. If the determined metric does not satisfy a corresponding image quality threshold (e.g., a sharpness threshold, an exposure threshold, and/or a noise threshold), the image may be recaptured.

While the probe assembly moves relative to the object, non-destructive test data may be acquired via the non-destructive testing sensor. The non-destructive test data may include ultrasonic testing (UT) data, phased-array ultrasonic testing (PAUT) data, or eddy current array (ECA) data.

Based on the non-destructive test data, a defect within the object may be detected. The method may include determining a corresponding location within the composite image and visually indicating the location on a display. Determining the corresponding location may include mapping the defect position within the coordinate system to a location within the composite image, enabling precise spatial correlation between detected defects and their visual representation.

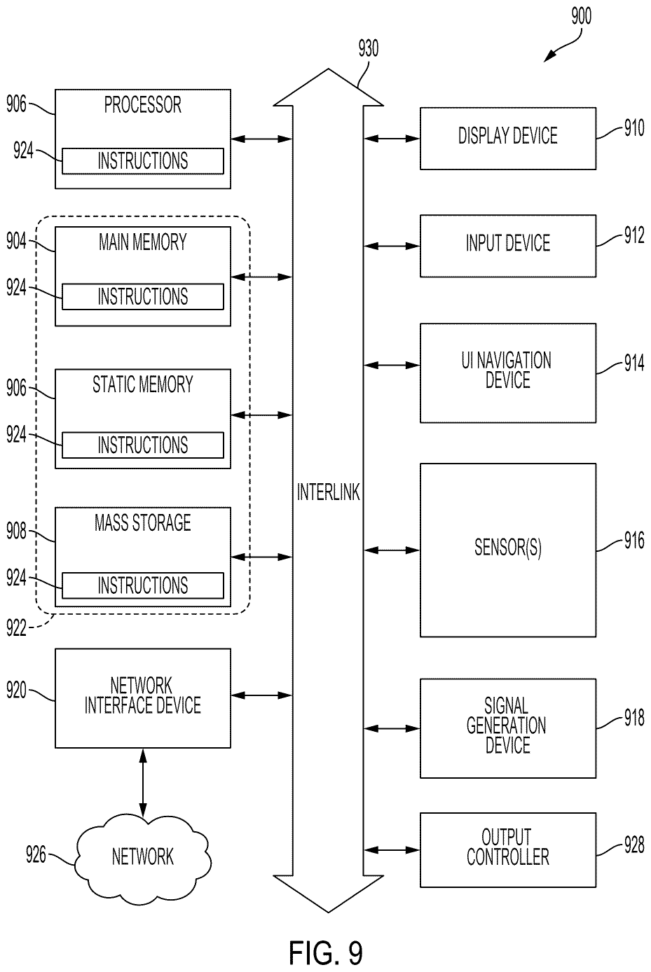

FIG. 9 illustrates a block diagram of an example comprising a machine 900 upon which any one or more of the techniques (e.g., methodologies) discussed herein may be performed. Machine 900 (e.g., computer system) may include a hardware processor 902 (e.g., a central processing unit (CPU), a graphics processing unit (GPU), a hardware processor core, or any combination thereof), a main memory 904 and a static memory 906, connected via an interlink 930 (e.g., link or bus), as some or all of these components may constitute hardware for systems or related implementations discussed above.

Generally, the hardware processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory include Random Access Memory (RAM), and semiconductor memory devices, which may include storage locations in semiconductors such as registers. Specific examples of static memory include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine may further include a display device 910, an input device 912 (e.g., a keyboard), and a user interface (UI) navigation device 914 (e.g., a mouse). In an example, the display device, input device, and UI navigation device may be a touch-screen display. The machine may include a mass storage device 908 (e.g., drive unit), a signal generation device 918 (e.g., a speaker), a network interface device 920, and one or more sensors 916, such as a global positioning system (GPS) sensor, compass, accelerometer, or some other sensor. The machine may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device may comprise a machine-readable medium 922 on which is stored one or more sets of data structures or instructions 924 (e.g., software) embodying or utilized by any one or more of the techniques or functions described herein. The instructions may also reside, completely or at least partially, within the main memory, within static memory, or within the hardware processor during execution thereof by the machine. In an example, one or any combination of the hardware processor, the main memory, the static memory, or the mass storage device comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions.

An apparatus of the machine includes one or more of a hardware processor (e.g., a central processing unit (CPU), a graphics processing unit (GPU), a hardware processor core, or any combination thereof), a main memory and a static memory, sensors, network interface device, antennas, a display device, an input device, a UI navigation device, a mass storage device, instructions, a signal generation device, or an output controller. The apparatus may be configured to perform one or more of the methods or operations disclosed herein.

The term “machine readable medium” includes, for example, any medium that is capable of storing, encoding, or carrying instructions for execution by the machine 900 and that cause the machine 900 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions may be transmitted or received, for example, over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device includes one or more physical jacks (e.g., Ethernet, coaxial, or other interconnection) or one or more antennas to access the communications network. In an example, the network interface device includes one or more antennas to wirelessly communicate using at least one of single-input multiple-output (SIMO), multiple-input multiple-output (MIMO), or multiple-input single-output (MISO) techniques. In some examples, the network interface device wirelessly communicates using Multiple User MIMO techniques. The term “transmission medium” shall be taken to include any intangible medium that is capable of storing, encoding or carrying instructions for execution by the machine 900, and includes digital or analog communications signals or other intangible medium to facilitate communication of such software.

Each of the non-limiting aspects described herein can stand on its own or can be combined in various permutations or combinations with one or more of the other aspects or other subject matter described in this document.

The terms “control circuit” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features may be stored in various types of memory. Suitable memory may include dynamic random-access memory (DRAM), flash memory, and/or cache. These instructions may be distributed over a network or via other computer-readable media. The term “non-transitory computer-readable medium” refers to any physical medium capable of storing or transmitting instructions or information that may be read by a machine. Examples of suitable media include RAM, ROM, EPROM, EEPROM, magnetic or optical media, flash memory, or even propagated signals such as carrier waves or infrared signals.

In some embodiments, the control circuit may utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling.

Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques.

Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply may be based at least in part on characteristics of a given item of equipment or environment. For example, an artificial intelligence system, such as a neural network, may receive input of a number of environmental and task-related parameters. These parameters may include, for example, operational input of the given equipment, data from various sensors, environmental information, location and/or position data, and the like. The neural network may be trained and may generate an output based on these inputs, with the output representing an action or sequence of actions that the equipment or system should take to accomplish the goal of the operation. The control circuit may process the inputs through the parameters of the neural network to generate a value (e.g., make a determination) at the output node designating that action as the desired action, activity, or operating state. An action may translate into a signal that causes the vehicle to operate in a particular manner. The control circuit may accomplish this via backpropagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network may be generated and adjustments to the parameters may be made with subsequent simulations. Once the outputs from the various models have been obtained, they may be evaluated on their performance using a determined success metric. The best model or a good-enough model may be selected, and the control circuit may execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data may be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

The above description include references to the accompanying drawings, which form a part of the description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A method for non-destructive testing comprising:
receiving a position of a probe assembly relative to an object, the probe assembly comprising a non-destructive testing sensor and a camera;
capturing, by the camera, an image of the object at the received position;
associating the captured image with the received position by mapping the captured image to a coordinate system;
updating a composite image of the object by incorporating at least a portion of the captured image into the composite image based on the mapping; and
repeating the receiving, capturing, associating, and updating for multiple positions of the probe assembly to generate a completed composite image representing a region of the object.

2. The method of claim 1, further comprising receiving an orientation of the camera at each of the multiple positions, the orientation comprising one or more rotational components.

3. The method of claim 2, wherein associating the captured image with the received position comprises:
defining the position of the camera relative to the object according to a translation vector;
defining the orientation of the camera according to a rotational matrix;
defining a position of each pixel of the captured image relative to a frame of the camera according to a camera-frame pixel vector; and
applying the rotational matrix and translation vector to the camera-frame pixel vector to generate a coordinate-system pixel vector.

4. The method of claim 3, wherein defining the camera-frame pixel vector comprises:
defining an intrinsic characteristic matrix for the camera including focal length and principal point coordinates;
determining a depth of the image based on a distance between the camera and the object; and
applying the depth and the intrinsic characteristic matrix to integer pixel coordinates to generate the camera-frame pixel vector.

5. The method of claim 1, wherein updating the composite image comprises selecting a region of the captured image based on a displacement of the probe assembly between successive positions and incorporating the selected region into the composite image.

6. The method of claim 1, wherein receiving the position of the probe assembly comprises receiving an absolute position and comparing the absolute position to a reference position of the object.

7. The method of claim 1, wherein receiving the position comprises determining the position based on a previous position and encoder data of one or more motors repositioning the probe assembly.

8. The method of claim 1, further comprising determining a displacement between the received position and a previous position, comparing the displacement to a displacement threshold, and capturing the image in response to the displacement satisfying the threshold.

9. The method of claim 1, further comprising evaluating an image quality metric of the captured image against a quality threshold and repeating capture in response to the captured image quality metric failing to satisfy the quality threshold.

10. The method of claim 1, further comprising acquiring non-destructive test data via the non-destructive testing sensor while the probe assembly moves relative to the object, the non-destructive test data comprising ultrasonic testing data, phased-array ultrasonic testing data, or eddy current array data.

11. The method of claim 10, further comprising detecting a defect within the object based on the non-destructive test data, determining a corresponding location within the composite image, and visually indicating the location on a display.

12. The method of claim 11, wherein determining the corresponding location comprises:
determining a position of the detected defect within the coordinate system; and
mapping the defect position to a location within the composite image.

13. A system for non-destructive testing comprising:
a probe assembly comprising a non-destructive testing sensor and a camera; and
a processor circuit configured to:
receive a position of the probe assembly relative to an object;
capture an image at the received position;
map the captured image to a coordinate system; and
update a composite image by incorporating at least a portion of the captured image based on the mapping.

14. The system of claim 13 further comprising a robot configured to reposition the probe assembly, wherein the processor circuit is configured to repeatedly receive probe positions, capture images, map images, and update the composite image to generate a completed composite image of the object.

15. The system of claim 13, wherein the processor circuit is further configured to determine an orientation, translation, and rotation of the camera and to apply a rotational matrix and translation vector to pixel positions of the captured image.

16. The system of claim 15, wherein the processor circuit is configured to apply an intrinsic characteristic matrix and a depth estimate to pixel coordinates to generate camera-frame vectors.

17. The system of claim 13, wherein the non-destructive testing sensor comprises an ultrasonic transducer, an ultrasonic transducer array, or an eddy current array probe.

18. The system of claim 13, further comprising a display, wherein the processor circuit is configured to detect defects based on the non-destructive test data and highlight corresponding locations within the composite image.

19. The system of claim 18, wherein the processor circuit is further configured to map defect positions within the coordinate system to locations within the composite image.

20. A method, comprising:
receiving, for each of a plurality of positions of a probe assembly relative to an object under inspection, position data defining a position of the probe assembly in a coordinate system, the probe assembly comprising a non-destructive testing sensor and a camera;
acquiring, via the non-destructive testing sensor, non-destructive test data for the object at the plurality of positions;
capturing, via the camera, a plurality of images of the object respectively at the plurality of positions;
for each captured image, associating the captured image with the coordinate system based on the received position data;
mapping the captured images to a coordinate system to associate the captured with the plurality of positions and orientations;
updating a composite image by incorporating, for each captured image, at least a portion of the captured image into the composite image according to the association with the coordinate system;
detecting, based on the non-destructive test data, a defect in the object;
determining a defect location of the defect within the coordinate system; and
displaying at least a portion of the composite image with a visual overlay indicating the defect location within the composite image.
